(19) United States
(12) Patent Application Publication
(10) Pub. No.: US 2026/0241658 A1
(43) Pub. Date: Aug. 20, 2026

(54) APPARATUS FOR CLEANING A POWDER PRESS DEVICE, COMBINATION OF A POWDER PRESS DEVICE WITH SUCH A CLEANING APPARATUS, AND METHOD FOR CLEANING A POWDER PRESS DEVICE

(71) Applicant: DORST TECHNOLOGIES GMBH & CO. KG, Kochel am See (DE)

(72) Inventor: Wolfgang BRANDL, Bad Kötzting (DE)

(21) Appl. No.: 18/876,587

(22) PCT Filed: Jun. 20, 2023
(86) PCT No.: PCT/EP2023/066632

§ 371 Date: Dec. 18, 2024

(30) Foreign Application Priority Data
Jun. 20, 2022 (DE) 10 2022 115 278.2

(51) Int. Cl. B30B 15/00; B08B 1/12; B08B 1/36; B08B 3/02; B08B 5/04; B08B 7/02; B08B 7/04; B30B 11/00

(52) U.S. Cl. CPC B30B 15/0082; B08B 1/12; B08B 1/36; B08B 3/024; B08B 5/04; B08B 7/028; B08B 7/04; B30B 11/00

(57) ABSTRACT

The invention relates to a device for cleaning a powder press device, in particular a metal powder and/or ceramic powder press device, whereby the cleaning device has a movable cleaning head which, within a housing, in particular a suction enclosure, has at least one brush as well as at least one nozzle for dispensing a fluid and at least one suction device, as well as a combination of a powder press device, in particular a metal powder and/or ceramic powder press device, with such a cleaning device, as well as, furthermore, a method for cleaning a powder press device by means of such a cleaning device.

The invention relates to a device for cleaning a powder press device according to the preamble of claim 1, a combination of a powder press device with such a cleaning device according to the preamble of claim 10, and a method for cleaning a powder press device using such a cleaning device according to the preamble of claim 11.

In pressing devices in which powdery materials are pressed in form, the tool parts must be cleaned after use. Such a cleaning is usually carried out by means of a device after the pressed object, such as a moulded part, has been removed from the mould, whereby the object pressed in form is first removed from the press by means of a gripping device, which is usually done automatically. After the removal of the object pressed in form, the cleaning follows, whereby the device used for this purpose is either designed as part of the gripping device and thus disadvantageously ‘travels along’ with each removal process of the gripping device, which is disadvantageous, or is designed as a separate device and is coupled to the gripping device each time a cleaning cycle is due.

Conventional cleaning devices consist of a rotating brush in accordance with the state of the art. During a cleaning process, the cleaning device with the rotating brush is guided along the tool parts on a defined path in the press, thereby detaching adhering particles. After this brushing-off cleaning process, these particles then lie in the press chamber and have to be detached manually by an operator of the press device. The cleaning process prior to the manual final cleaning of the press devices according to the state of the art is carried out in an automated manner and, according to the current state of the art, can only be carried out in a dry state.

In particular, with critical materials to be pressed, for example those that adhere strongly to the active surfaces of the pressing tools, this previous procedure for cleaning a pressing device has the disadvantage that the automatic cleaning process using a coupled or carried cleaning machine is often insufficient, and the operator of the pressing device has to secondary clean manually with cleaning agent at fixed intervals. An operator usually has to look after several systems. This manual secondary cleaning work inevitably causes the pressing plant to come to a standstill. The object of the invention is to overcome the disadvantages associated with the prior art and to provide a device for cleaning a pressing device by which a need for a manual intervention by an operator is reduced, rendered unnecessary and/or limited to a minimum, in order to minimise downtimes of the pressing device in this manner. Furthermore, the object of the invention is to provide a combination of a pressing device with a cleaning device with which the above-mentioned object is fulfilled, as well as a method for cleaning a pressing device.

This object is solved with a device according to claim 1.

In particular, this object is solved with a device for cleaning a powder press device, in particular a metal powder and/or ceramic powder press device, wherein the cleaning device has a movable cleaning head, which, within a housing, in particular a suction enclosure, has at least one brush as well as at least one nozzle for dispensing a fluid and at least one suction device.

Herein the cleaning head is the movable part of a cleaning device, which, according to one embodiment of the invention, is designed to be autonomously movable and/or, according to an alternative embodiment of the invention, in an extremely advantageous manner, can be gripped by a gripping device, which is also used to remove a pressed moulding from the press, and can be moved to the machine parts to be cleaned. For the sake of completeness, it should be mentioned here that a separate positioning device can also be used for this purpose instead of a gripping device of the pressing device.

The cleaning head, in turn, consists of a housing that is designed in the form of an enclosure. According to the invention, at least one brush, at least one nozzle and at least one end of a suction device are arranged within the housing. In an extremely advantageous manner, the cleaning head brought into position can thus perform a mechanical cleaning of the machine parts of the pressing device that are to be cleaned by means of the at least one brush, whereby a distribution of the detached dirt particles in the environment is avoided by the housing surrounding the brush.

According to a further extremely advantageous point of the invention, a fluid can also be introduced via the nozzle also arranged in the housing into the cleaning chamber, which is defined by the housing, of the cleaning device according to the invention, which fluid supports the cleaning process of the brush in that the fluid contributes to a detachment of dirt particles from the machine parts to be cleaned. Depending on the pressing material, the fluid may be a cleaning fluid such as water or a solvent or mixtures of different cleaning fluids that are best suited to support the mechanical cleaning effect of the brush.

According to the invention, the fluid can be applied by means of spray nozzles or as a hard jet, whereby the nozzles used can be controllable individually or in combination with each other and can be swivelled in their direction.

According to a further extremely advantageous point of the invention, the cleaning device according to the invention also has a suction device, by means of which it is possible to suck off both the dirt particles detached from the machine parts to be cleaned and the cleaning fluid introduced, as well as any vapours that may have arisen from it. According to the invention, several suction devices can be used for this purpose, wherein, for example, a suction device is assigned to each brush and/or nozzle. According to a further embodiment of the invention, also a single suction device can be provided for the entire housing of the cleaning head of the cleaning device according to the invention.

In an extremely advantageous manner, it is possible in this way, by means of the cleaning device according to the invention, to remove the dirt particles detached from the machine parts to be cleaned completely from the pressing device, so that manual secondary cleaning by an operator can be largely or, in the best case, completely avoided, which in turn in an extremely advantageous manner leads to the fact that any downtimes of a pressing device can be minimised by using the cleaning device according to the invention.

According to one embodiment of the invention, at least the cleaning head of the cleaning device according to the invention, as movable part of the cleaning device according to the invention, is arranged close to the pressing tool, or a possible removal station of the pressing tool, so that the cleaning head can be gripped automatedly by the gripping device of the pressing device as soon as the gripping device has removed the pressed moulded part from the pressing device. The cleaning device according to the invention is thus always located in a parking position within reach of the removal station of the pressing tool when no cleaning process is taking place and is only ever picked up by the gripping device of the pressing device and brought to the correct position within the pressing device in order to clean the machine parts that are to be cleaned when a cleaning or a cleaning cycle is due.

In this manner it can be avoided that the cleaning head or the entire cleaning device has to participate in or travel along every movement of the gripping device. The press device can thus be designed in an extremely advantageous, weight-optimised way, whereby the press device can not be operated in a more energy saving manner but also at a higher speed due to its lower mass.

According to an embodiment of the invention, the cleaning device has at least one first hose for supplying the at least one nozzle with fluid, as well as at least one second hose for applying negative pressure to the at least one suction device and for disposing of the material sucked out.

By means of these hoses, in particular the first hose, a fluid or a fluid mixture that is particularly suitable for cleaning the respective machine parts can be supplied to the cleaning head, starting from a stationary part of the cleaning device according to the invention. Furthermore, a negative pressure can be applied to the housing or inside the suction enclosure via these hoses, in particular the second hose, in order to suck detached dirt, used or excess fluid and any vapours out of the housing and dispose of them properly.

According to a further embodiment of the invention, the cleaning device also has at least one compressed air hose for introducing compressed air into the cleaning head, in particular to at least one compressed air nozzle.

In an advantageous manner, the mechanical cleaning process of tool parts can in this way be supported with compressed air by directing a compressed air jet onto the respective locations to be cleaned. Furthermore, the compressed air or compressed air jet can also be used to blow dirt particles off the surface of the tool parts to be cleaned, whereupon these dirt particles are then removed from the housing of the pressing device by the suction device. The use of compressed air is particularly advantageous in particular if the press device has angled and difficult-to-access regions that are difficult to access using mechanical cleaning means and in which dirt particles that have already been detached from the tool parts could accumulate. According to the invention, such difficult-to-access regions can be blown out with compressed air. This is particularly effective if the cleaning of the housing of the pressing device is carried out both mechanically as well as fluid assisted and compressed air assisted.

According to a further embodiment of the invention, the cleaning device also has at least one ultrasonic emitter that can be used to detach particularly persistent adhesions from the surfaces of tool parts. In an advantageous manner, the ultrasonic emitter is integrated into a brush head for this purpose and, according to a special embodiment of the invention, is suitable for stimulating the at least one brush in such a way that the vibration generated by the ultrasonic emitter, in combination with the cleaning effect of the brush, causes an optimal cleaning of the surface. In this case, the brush can be used in a rotating manner or merely to wipe dirt particles off the surface of the tool parts to be cleaned. In this context, it should be noted that the brush can generally perform a rotating movement, a rotating back-and-forth movement or a translational movement, which can also be executed as a back-and-forth movement, as desired and in coordination with the tool part to be cleaned. Likewise, a combination of the movements makes it possible to follow spatial trajectories. A lateral tilting movement, in particular back and forth, of the brush is also possible. In an analogous manner, the fluid and compressed air nozzles of the cleaning device according to the invention can be moved and controlled so that every corner of the housing of the pressing device can be optimally reached both mechanically as well as fluidically and with compressed air.

For the rotational drive of the brushes, a rotational drive is provided in accordance with the invention, which sets the respective brushes in rotational motion via a respectively assigned drive shaft. In an analogous manner, a translational drive, for example a linear motor, can be provided for a translational movement of the brushes.

For this purpose, the respective cleaning units, i.e. in particular the brushes and nozzles used, in each case in particular individually or combined in groups, are controllable and pivotable in any technically possible direction. The same also applies to any suction nozzles, whereby the latter is particularly helpful for sucking dirt particles as well as used or excess fluid out of even the hard-to-reach regions of the press device to be cleaned.

At this point, it should be noted that, in particular, both the possibility to rinse the housing of the press device to be cleaned with fluid and/or compressed air, as well as to remove residues, such as dirt particles, and excess clean as well as contaminated fluid from the housing of the press device to be cleaned, represents an essential point of the invention, which makes it possible to minimise or completely avoid the necessity for manual intervention.

According to a further embodiment of the invention, during a cleaning of the press device according to the invention, an optical control of the tool parts to be cleaned can also, optionally simultaneously, be carried out, which can be carried out, for example, by means of a camera and an associated dirt recognition software. In this way, the success of the cleaning can be checked directly in situ during the cleaning process.

According to a particularly advantageous variant of the invention, the ultrasonic emitter can be supplied with energy by means of an induction coil. In this way, complicated cable routing within the cleaning device, or within the housing of the pressing device to be cleaned, can be avoided.

According to a further embodiment of the invention, the at least one first hose and the at least one second hose, as well as, if applicable, the at least one compressed air hose and/or at least one energy supply line, are guided in a collecting hose, in particular a hose package.

Such an embodiment offers the advantage that the stationary part of the cleaning device according to the invention can be connected to the cleaning head, that is, the actual cleaning unit of the cleaning device according to the invention by a single collecting hose or a hose package, in which several hoses are guided essentially parallel to one another and are connected to one another, thereby forming a hose unit or a hose package. In this way, the individual hoses, as well as the energy supply line, can be routed in parallel and bundled without fear of the individual hoses and lines becoming entangled when the cleaning head moves.

Furthermore, the object of the invention is also solved by a combination of a powder press device, in particular a metal powder and/or ceramic powder press device, with a device for cleaning a powder press device, in particular a metal powder and/or ceramic powder press device, according to the above explanations, wherein the powder press device has a gripping device with which pressed moulded parts can be removed from a press of the powder press device and the cleaning device is stored until a cleaning operation in a parking station close to the powder press device, which parking station is accessible for the removal axis of the gripping device.

In this way, it is possible in an extremely advantageous manner to combine the cleaning device according to the invention with a powder press device in such a way that a gripping device, which removes finished pressed blanks from the press in the regular shaping process of the powder press device, can also be used in order to, after a storing of the pressed blanks, grip the cleaning head, i.e., the mobile cleaning unit of the cleaning device according to the invention, and guide it to the tool parts of the powder press device to be cleaned, so that the cleaning head, with its brushes and nozzles, as well as its suction device, reaches the tool parts of the powder press device to be cleaned.

In this context, it should be noted that the cleaning head of the cleaning device according to the invention, as mentioned above, has a housing that acts as a suction enclosure, but the nozzles and brushes of the cleaning head protrude from this housing in such a way that the nozzles and brushes reach the tool parts to be cleaned. This is achieved according to the invention by openings in the housing and the suction enclosure, respectively, wherein the suction of dirt particles and fluid also takes place through these openings in the housing and the suction enclosure, respectively.

The suction can be performed simultaneously with the use of the brushes as well as, if applicable, the sprayed or injected fluid, so that a suction of fluid and dirt particles is performed directly in situ with the cleaning of the tool parts and the detachment of dirt particles from the tool parts.

According to an alternative embodiment of the invention, however, it may also be provided that initially a mechanical and optionally fluidic cleaning is carried out by means of brushes and optionally fluid via the dispensing nozzles of the fluid and that a suction of fluid and dirt particles is carried out only afterwards, wherein the brushes and nozzles used for cleaning are retracted from the openings of the housing so that the openings are now free for suction. If necessary, a suction nozzle can also be moved through the openings of the housing up to the respective tool parts to be sucked off for this purpose.

Furthermore, the object of the invention is also solved by a method for cleaning a powder press device, in particular a metal powder and/or ceramic powder press device, by means of a cleaning device according to the above explanations, wherein
a movable cleaning head of the cleaning device is removed, by means of a gripping device of the powder press device, from a parking station close to the powder press device and within reach of the gripping device to initiate a cleaning process and is introduced into a pressing chamber of the powder press device by means of the gripping device;
tool parts of the powder press device are cleaned by means of at least one brush, wherein a fluid, in particular a cleaning fluid, such as for example a solvent-containing cleaning fluid, is optionally supplied to the brush;
a suction of detached dirt particles and, possibly, of introduced fluid is carried out.

As desired, the cleaning method according to the invention can also be carried out with the aid of ultrasound, provided that a fluid is used.

In summary, the invention can thus be written as follows.

The new device according to the invention for cleaning the tool parts of a powder press device has a driven brush. Due to the geometry, arrangement and configuration of the device according to the invention it is possible in an advantageous manner to also bring various media, such as cleaning liquids and fluids, as well as compressed air, negative pressure and/or ultrasound, to the brush. By the cleaning agent the cleaning of the tool parts is improved and, equivalent to the manual cleaning that has been necessary up to now, the tool parts are freed form adhering dirt. The improved cleaning increases the productivity of the plant, since manual interventions are reduced or rendered unnecessary.

The device is stored close to the pressing tool in a parking station, which is accessible for the removal axis of the automation, i.e. the automated removal of pressed moulded parts by means of a gripping device, until the cleaning process. A media-carrying hose package is firmly connected to the device. Due to this hose package new functions in the cleaning of tool parts of a powder press device can now be realised according to the invention in an advantageous way. The main media used in accordance with the invention include, in particular, cleaning agents, compressed air, vacuum and electrical signals, for example, among other things, for energy supply.

During the cleaning process, the cleaning device according to the invention, or its cleaning head or cleaning unit, is guided to the tool by the removal axis or the gripping device. After that the cleaning process is started. The tool parts are cleaned with the brush. As desired, cleaning agents can be supplied to the brush. The suction around the brush prevents a distribution of the cleaning agent and the removed dirt in the working space of the press. In conjunction with a suitable suction unit, it is also possible to work with solvent containing cleaning agents.

The cleaning arrangement according to the invention enables, besides the supply of cleaning agent, also the suction of the excess cleaning agent and the detached dirt. The surroundings in the region of the tool parts are thus not contaminated with the cleaning agent.

To increase the cleaning effect, the brush can be equipped with an ultrasonic generator. In this case, the rotation of the brush can be dispensed with as desired. Due to the liquid-wetted brush the ultrasound can detach adhering particles. In combination with a rotation of the brush, the energy for operating the ultrasonic generator is transmitted to the brush via an induction coil.

Further embodiments of the invention arise from the dependent claims.

In the following, the invention is described by way of an example embodiment, which is explained in more detail with the help of the figures. Hereby show:

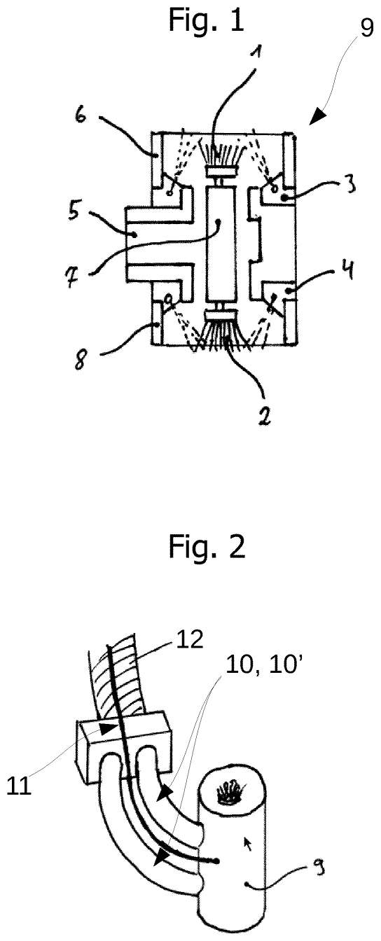

FIG. 1 a schematic representation of a cleaning head of a cleaning device according to the invention in a sketched sectional view; and

FIG. 2 a schematic representation of a cleaning head of a cleaning device according to the invention in a sketched perspective view.

In the following description, the same reference numbers are used for identical and similarly acting parts.

FIG. 1 shows a schematic representation of a cleaning head 9 of a cleaning device according to the invention in a sketched sectional view. It can be seen that the cleaning head 9 is designed in the form of a housing, in which a drive shaft 7 is located that extends vertically in the present example embodiment. On the drive shaft 7, at each of its respective ends symmetrically in the axial direction, a brush 1, 2 is arranged, wherein the respective distal end of the brush extends somewhat out of the housing so that the brush can reach the tool part to be cleaned or can be retracted into the housing. Furthermore, nozzles 3, 4 in the form of respective spray devices are arranged within the housing, through which a fluid can be sprayed in the direction of the respective cleaning brushes 1, 2. The brushes 1, 2 are surrounded laterally by preferably flexible covers 6, 8, whereby by the covers 6, 8 it is avoided that cleaning fluid spills out over parts of the press device and wets parts of the press device that are not to be cleaned. The covers 6, 8 can be designed flexible so that the respective brushes 1, 2 can be pressed against the tool parts to be cleaned in order to improve the cleaning effect in this way. The covers 6, 8 thus act as an apron against an undesired discharge of cleaning fluid and serve to keep dirt particles in the region of the action of a suction device 5, so that both cleaning fluid as well as dirt particles can be detached from the surface of the tool parts to be cleaned by the suction device and ultimately sucked out of the cleaning head 9, i.e. the actual cleaning unit 9 of the cleaning device according to the invention. The suction takes place in the direction of the stationary unit of the cleaning device according to the invention, from where both the energy supply of the cleaning unit as well as the supply of cleaning fluid to the cleaning unit take place. For this purpose, i.e. for supplying cleaning fluid, respective first and second hoses 10, 10′ are used, as shown in FIG. 2, while the energy supply to the cleaning head 9 is provided via an energy supply line 11. Both the hoses 10, 10′ as well as the energy supply line 11 are combined into a collecting hose 12 and/or bundled into a hose package 12 according to with the invention.

It should be noted at this point that all of the parts described above, when viewed individually and in any combination, in particular the details shown in the drawings, are claimed as essential to the invention. Modifications thereof are familiar to those skilled in the art.

### LIST OF REFERENCE SIGNS

1 brush
2 brush
3 nozzle/spray device
4 nozzle/spray device
5 suction device
6 cover
7 drive shaft
8 cover
9 cleaning head/cleaning unit
10 first hose
10′ second hose
11 energy supply line/energy supply
12 collecting hose/hose package

1. A device for cleaning a powder press device, in particular a metal powder and/or ceramic powder press device,
wherein
the cleaning device has a movable cleaning head which has, inside a housing, in particular a suction enclosure, at least one brush as well as at least one nozzle for dispensing a fluid and at least one suction device.

2. The cleaning device according to claim 1,
wherein
the cleaning device has at least one first hose for supplying the at least one nozzle with fluid, as well as at least one second hose for applying negative pressure to the at least one suction device and for disposing of material that has been sucked off.

3. The cleaning device according to claim 1,
wherein
the cleaning device further has at least one compressed air hose for introducing compressed air into the cleaning head, in particular to at least one compressed air nozzle.

4. The cleaning device according to claim 1,
wherein
the cleaning device further has at least one ultrasonic emitter.

5. The cleaning device according to claim 1,
wherein
the at least one first hose and the at least one second hose, as well as, optionally, the at least one compressed air hose and/or at least one energy supply line, are guided in a collecting hose, in particular a hose package.

6. The cleaning device according to claim 1,
wherein
the at least one brush can be set in rotation by means of a rotary drive and a respective drive shaft.

7. The cleaning device according to claim 4,
wherein
the ultrasonic emitter is integrated into a brush head and is suitable for exciting the at least one brush.

8. The cleaning device according to claim 4,
wherein
the ultrasonic emitter is supplied with energy by means of an induction coil.

9. The cleaning device according to claim 1,
wherein
respective cleaning units, in particular brushes and nozzles, are controllable, in particular individually, in particular pivotable.

10. A combination of a powder press device, in particular a metal powder and/or ceramic powder press device, with a device for cleaning a powder press device, in particular a metal powder and/or ceramic powder press device, according to claim 1,
wherein
the powder press device has a gripping device with which pressed moulded parts can be removed from a press of the powder press device and the cleaning device is stored, close to the powder press device, in a parking station accessible for the removal axis of the gripping device until a cleaning process.

11. A method for cleaning a powder press device, in particular a metal powder and/or ceramic powder press device, by means of a cleaning device according to claim 1,
wherein
a movable cleaning head of the cleaning device is removed, by means of a gripping device of the powder press device, from a parking station close to the powder press device and within reach of the gripping device to initiate a cleaning process, and is introduced into a pressing chamber of the powder press device by means of the gripping device;
tool parts of the powder press device are cleaned by means of at least one brush, wherein a fluid, in particular a cleaning fluid, such as for example a solvent-containing cleaning fluid, is optionally supplied to the brush; and
a suction of detached dirt particles and, possibly, of introduced fluid is carried out.

12. The method according to claim 11,
wherein
a cleaning process with the aid of fluid is supported by means of ultrasound.
